(19) United States
(12) Patent Application Publication
(10) Pub. No.: US 2012/0107064 A1
(43) Pub. Date: May 3, 2012

(54) CNC Machine Tool Having Two Spindles

(76) Inventor: Feng-Tien Chen, Taichung City (TW)

(21) Appl. No.: 13/279,309

(22) Filed: Oct. 23, 2011

(30) Foreign Application Priority Data
Oct. 29, 2010 (TW) 0099220995

(51) Int. Cl. B23C 1/08

(52) U.S. Cl. 409/203

(57) ABSTRACT

A machine tool includes a base, a saddle movable on the base in a front-to-rear direction, a worktable movable on the saddle in a left-to-right direction, a post member disposed fixedly on a rear end of the base, a sliding seat movable vertically on the post member, a first spindle disposed rotatably on the sliding seat, and a second spindle movable vertically and rotatable on the sliding seat and spaced apart from the first spindle in the front-to-rear direction.

### CROSS-REFERENCE TO RELATED APPLICATION

This application claims priority from Taiwanese Application No. 099220995, filed on Oct. 29, 2010.

### BACKGROUND OF THE INVENTION

1. Field of the Invention

This invention relates to a CNC (Computer-Numerical-Controlled) machine tool, and more particularly to a CNC machine tool having two spindles.

2. Description of the Related Art

Referring to FIG. 1, a conventional CNC machine tool 10 includes a base 11, a saddle 12 movable on the base 11 in a front-to-rear direction (Y), a worktable 13 movable on the saddle 12 in a left-to-right direction, a post member 14 disposed fixedly on a rear end of the base 11, a sliding seat 15 movable vertically on the post member 14, and a spindle 16 disposed rotatably on a front end of the siding seat 15. A workpiece (not shown) can be held on the worktable 13. A cutter (not shown) can be disposed on a lower end of the spindle 16. As such, the workpiece can be carried by the worktable 13 to a predetermined position, and the spindle 16 can be driven to rotate the cutter for cutting the workpiece. A similar CNC machine tool is disclosed in U.S. Pat. No. 7,147,595, issued to Hsi-Kuan Chen who is the applicant of this application and whose current name is Feng-Tien CHEN.

The conventional CNC machine has a drawback. That is, since only one spindle 16 is used to perform the cutting operation, the cutting efficiency is too small to satisfy mass production.

To solve the efficiency problem, referring to FIG. 2, another conventional CNC machine tool 20 disclosed in Taiwanese Utility Model Patent Application No. 099205341 includes a base 21, a saddle 22 movable on the base 21, a worktable 23 movable on the saddle 22, a post member 24 disposed fixedly on a rear end of the base 21, two sliding seats 25 movable on the post member 24, two servo driving units 26 disposed on the post member 24 for driving vertical movement of the sliding seats 25, respectively, and first and second spindles 27 disposed respectively on front ends of the sliding seats 25. A plurality of workpieces can be held on the worktable 23. Two cutters (not shown) can be mounted respectively to the first and second spindles 27 to cut two of the workpieces at the same time so as to promote the cutting efficiency.

The conventional CNC machine tool 20 suffers from the following drawbacks:
1. The servo driving units 26 are disposed for driving the sliding seats 25, respectively. Each of the servo driving units 26 includes two linear rails, a ball screw, four sliding blocks, and a servo motor, thereby increasing the manufacturing cost of the machine tool 20.
2. Due to the presence of the servo driving units 26 disposed on the post member 24, the post member 24 must be huge, thereby resulting in an increase in the volume and the material cost of the machine tool 20.
3. since the spindles 27 are spaced apart from each other in a left-to-right direction (X), the maximum distance traveled by the worktable 23 (i.e. the horizontal distance either between the axis of the left spindle 27 and the right end of the worktable 23 or between the axis of the right spindle 27 and the left end of the worktable 23) is much more than one half of the length of the worktable 23 in the left-to-right direction (X), so that the space occupied by the machine tool 20 is increased to thereby further increase the costs.

### SUMMARY OF THE INVENTION

The object of this invention is to provide a CNC machine tool that has two spindles arranged in a manner to improve the cutting efficiency and reduce the costs.

According to this invention, a machine tool includes a base, a saddle movable on the base in a front-to-rear direction, a worktable movable on the saddle in a left-to-right direction, a post member disposed fixedly on a rear end of the base, a sliding seat movable vertically on the post member, a first spindle disposed rotatably on the sliding seat, and a second spindle movable vertically and rotatable on the sliding seat and spaced apart from the first spindle in the front-to-rear direction.

As such, when two cutters are mounted respectively to the first and second spindles, and when the second spindle is disposed at an upper limit position, the cutter disposed on the first spindle can be driven to cut a large-sized workpiece. Or, the second spindle can be moved downwardly from the upper limit position, so that the cutters can be driven to cut two small-sized workpieces simultaneously, thereby promoting the cutting efficiency. Furthermore, since the first and second spindles are spaced apart from each other in the front-to-rear direction, during operation, the maximum distance traveled by the worktable can be reduced significantly so as to further promote the cutting efficiency.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 a side view of a conventional CNC machine tool;

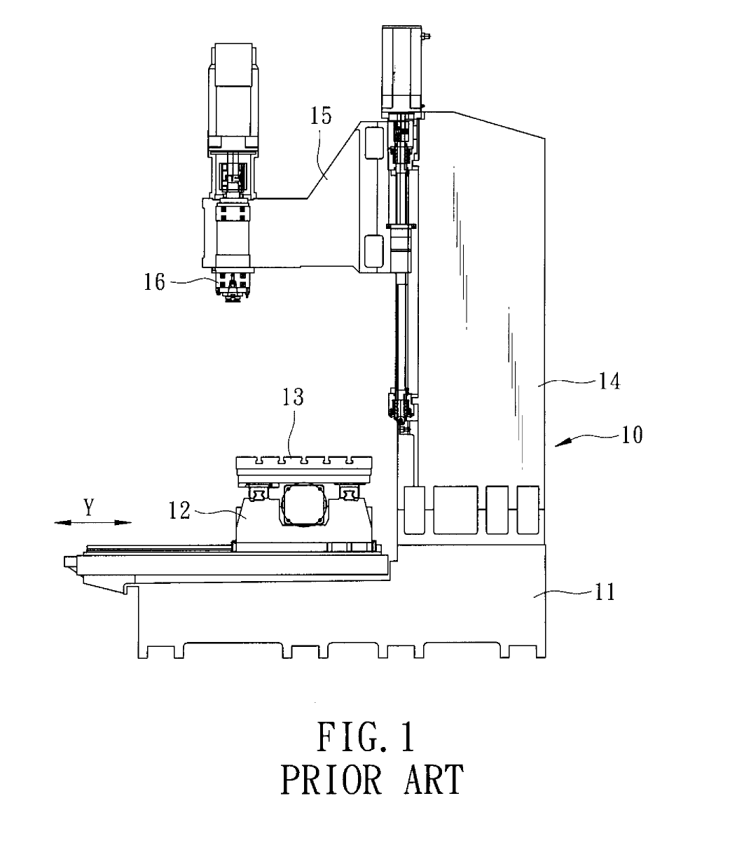

FIG. 2 is a front view of another convention CNC machine tool, which is disclosed in Taiwanese Utility Model Patent Application No. 099205341;

FIG. 3 is a side view of the preferred embodiment of a CNC machine tool according to this invention;

FIG. 4 is a front view of the preferred embodiment;

FIG. 5 is a side view of the preferred embodiment, illustrating that a second spindle is moved downwardly to align with a first spindle so that two cutters can be mounted respectively to the first and second spindles for cutting two small-sized workpieces, respectively;

FIG. 6 is a schematic top view illustrating an arrangement of a plurality of small-sized workpieces on a worktable of the preferred embodiment;

FIG. 7 is a schematic side view of the preferred embodiment, illustrating that the second spindle is moved upwardly to an upper limit position to allow a cutter to be mounted to the first spindle for cutting a large-sized workpiece; and

FIG. 8 is a schematic top view illustrating that the large-sized workpiece is held on a middle portion of the worktable.

### DETAILED DESCRIPTION OF THE PREFERRED EMBODIMENT

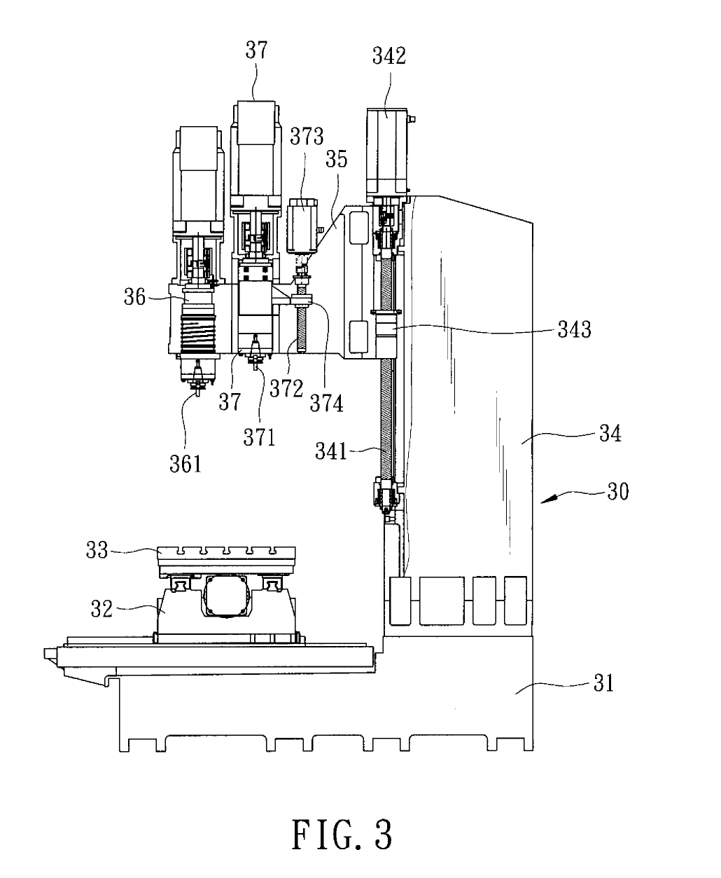

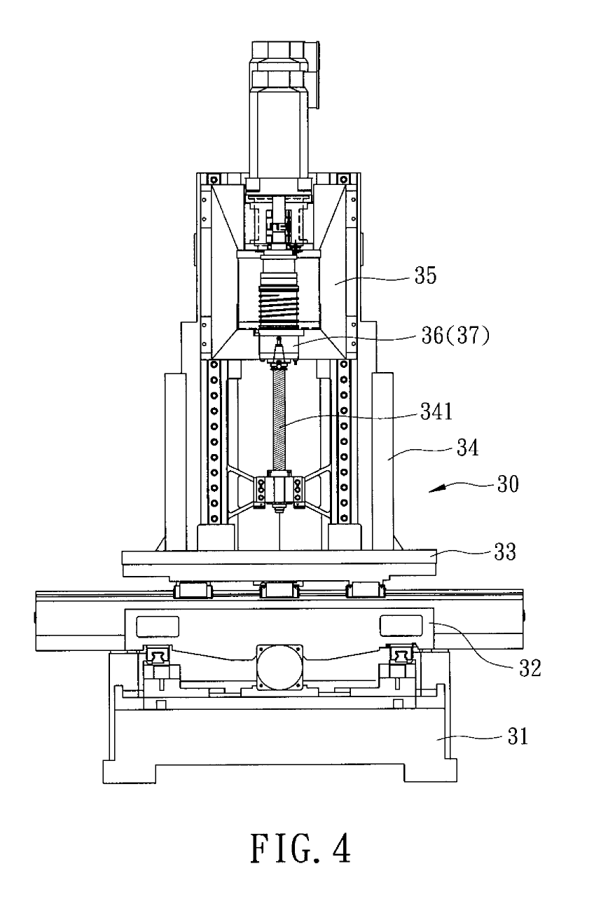

Referring to FIGS. 3 and 4, the preferred embodiment of a CNC machine tool 30 according to this invention includes a base 31, a saddle 32 movable on the base 31 in a front-to-rear direction, a worktable 33 movable on the saddle 32 in a left-to-right direction, a post member 34 disposed fixedly on a rear end of the base 31, a sliding seat 25 movable vertically on the post member 34, and a first spindle 36 disposed rotatably on a front end of the sliding seat 35. A first driving unit is disposed for driving vertical movement of the sliding seat 35 on the post member 34, and includes a first threaded rod 341 disposed rotatably on the post member 34, a first driving motor 342 disposed on the post member 34 and above the first threaded rod 341 for driving rotation of the first threaded rod 341, and a first internal thread member 343 connected to the sliding seat 35 and engaging the first threaded rod 341 such that rotation of the first threaded rod 341 results in vertical movement of the sliding seat 35. In this embodiment, the first driving motor 392 is a servo motor. A first cutter 361 (see FIG. 3) can be mounted to a lower end of the first spindle 36.

The CNC machine tool 30 further includes a second spindle 37 rotatable and movable vertically on the sliding seat 35, and a second driving unit for driving vertical movement of the second spindle 37 on the sliding seat 35. The second spindle 37 is disposed behind the first spindle 36. A second cutter 371 can be mounted to a lower end of the second spindle 37. The second driving unit includes a second threaded rod 372 disposed rotatably on the sliding seat 35, a second driving motor 373 disposed on the sliding seat 35 and above the second threaded rod 371 for driving rotation of the second threaded rod 371, and a second internal thread member 374 connected to the second spindle 37 and engaging the second threaded rod 371 such that rotation of the second threaded rod 371 results in vertical movement of the second spindle 37 on the sliding seat 35. In this embodiment, the second driving motor 373 is a servomotor.

Operation of the CNC machine tool 30 will now be described in the following.

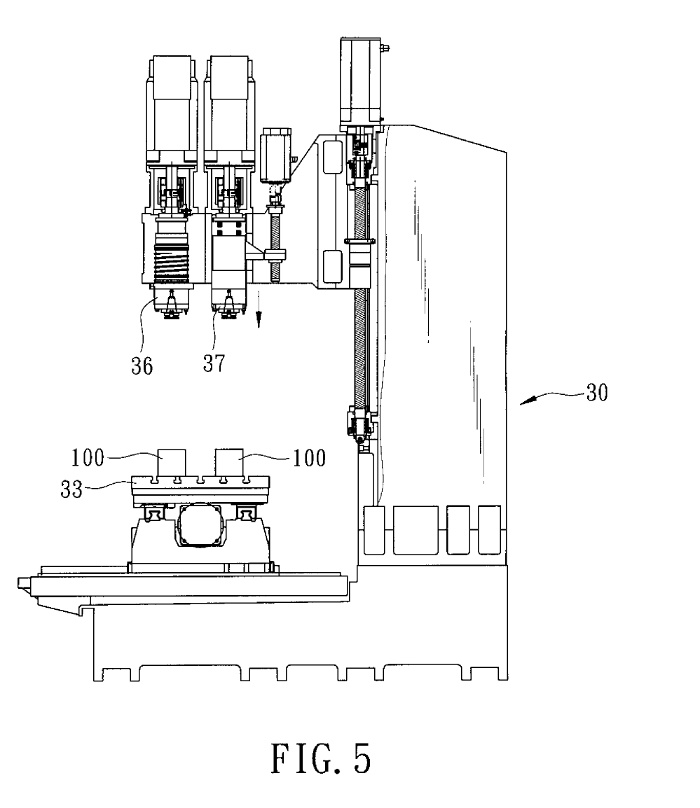

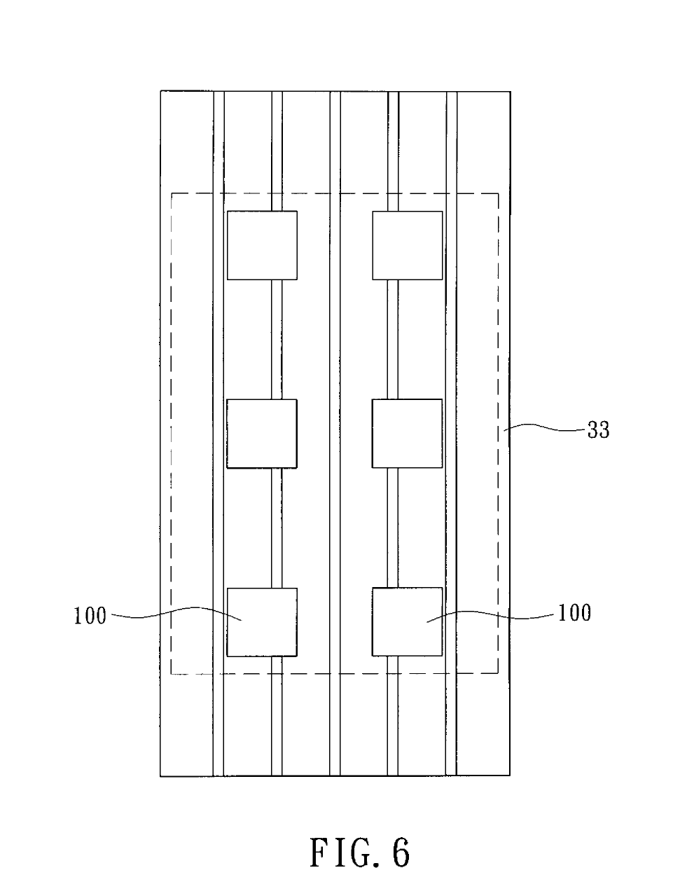

Referring to FIGS. 5 and 6, when it is desired to cut a plurality of small-sized workpieces 100, the small-sized workpieces 100 are first held on the worktable 33. Next, the second spindle 37 is moved downwardly to align with the first spindle 36, such that lower ends of the first and second spindles 36, 37 are at the same level, so as to allow the first and second cutters 361, 371 to be mounted respectively to the first and second spindles 36, 37, in preparation for cutting the small-sized workpieces 100.

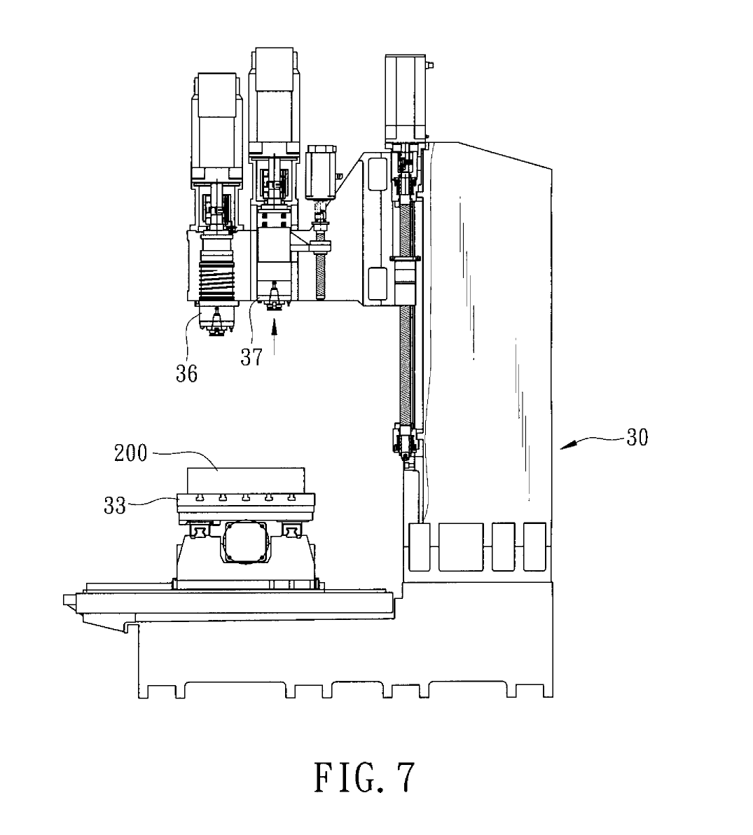

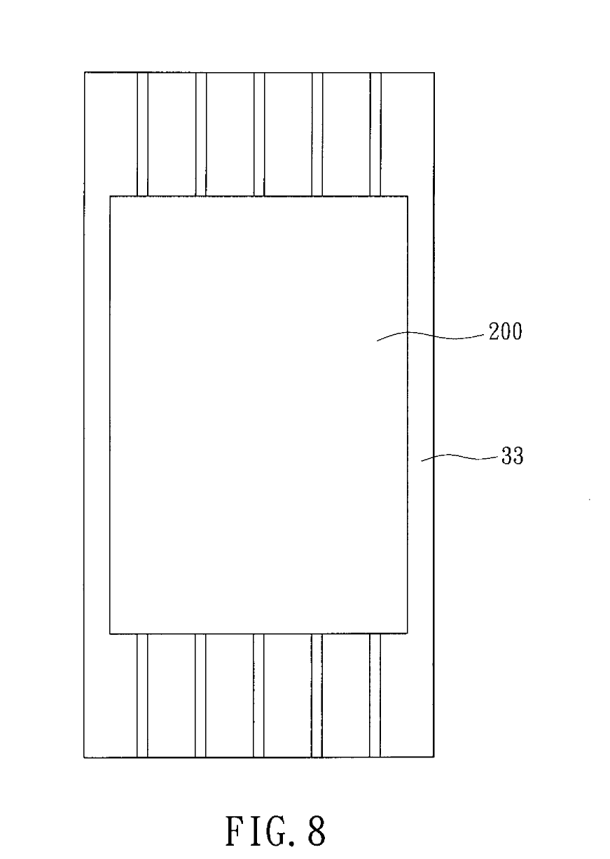

Referring to FIGS. 7 and 8, subsequently, when it is desired to cut a large-sized workpiece 200, to avoid contact between the second spindle 37 and the large-sized workpiece 200, the second spindle 37 is moved upwardly to an upper limit position shown in FIG. 7 to facilitate smooth cutting operation of the first spindle 36 performed on the large-sized workpiece 200.

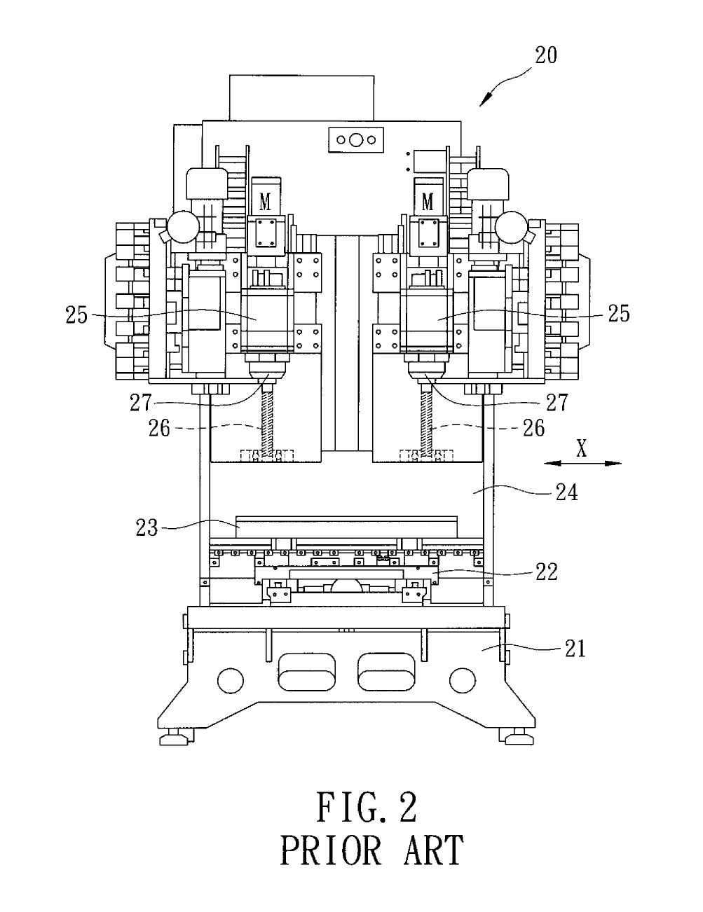

In view of the above, the CNC machine tool 30 of this invention has the following advantages:
1. By moving the second spindle 37 vertically, the CNC machine tool 30 can be operated to cut a single large-sized workpiece 200 by the first cutter 361 or two small-sized workpieces 100 by the first and second cutters 361, 371 at a time, thereby resulting in convenience during use.
2. The CNC machine tool 30 includes a single sliding seat 35 for mounting the first and second spindles 36, 37. Thus, the manufacturing cost of the CNC machine tool 30 is reduced, as compared to the conventional CNC machine tool 20 (see FIG. 2) disclosed in Taiwanese Utility Model Patent Application No. 099205341.
3. The maximum distance traveled by the worktable 33 is approximate to only one half of the length of the worktable 33 in the left-to-right direction, thereby improving the operating efficiency and reducing the material cost of the CNC machine tool 30 and the space occupied by the CNC machine tool 30.

With this invention thus explained, it is apparent that numerous modifications and variations can be made without departing from the scope and spirit of this invention. It is therefore intended that this invention be limited only as indicated by the appended claims.

I claim:

1. A machine tool comprising:
a base;
a saddle movable on said base in a front-to-rear direction;
a worktable movable on said saddle in a left-to-right direction;
a post member disposed fixedly on a rear end of said base;
a sliding seat movable vertically on said post member;
a first spindle disposed rotatably on said sliding seat; and
a second spindle movable vertically and rotatable on said sliding seat and spaced apart from said first spindle in the front-to-rear direction.

2. The machine tool as claimed in claim 1, further comprising a driving unit for driving said second spindle to move vertically on said sliding seat, said driving unit including a threaded rod disposed rotatably on said sliding seat, an internal thread member connected to said second spindle and engaging said threaded rod, a driving motor disposed on said sliding seat and operable for driving said threaded rod to rotate, rotation of said threaded rod resulting in vertical movement of said second spindle relative to said sliding seat.

3. The machine tool as claimed in claim 2, wherein said driving motor is a servomotor.
